(19) United States
(12) Patent Application Publication
(10) Pub. No.: US 2008/0207431 A1
(43) Pub. Date: Aug. 28, 2008

(54) METHOD FOR IMPROVING THE MANUFACTURE OF STRUCTURAL CLAY PRODUCTS

(75) Inventors: Glen Thomas Townley, Charlotte, NC (US); Jesse Daniel Bennett, Charlotte, NC (US)

Correspondence Address: HAMMER & ASSOCIATES, P.C., 3125 SPRINGBANK LANE, SUITE G, CHARLOTTE, NC, 28226, US

(73) Assignee: Aquasol Corporation

(21) Appl. No.: 11/678,259

(22) Filed: Feb. 23, 2007

(51) Int. Cl. C04B 33/00

(52) U.S. Cl. 501/145

(57) ABSTRACT

A method of improving the manufacture of structural clay products through the addition of starches is disclosed herein. The method includes adding a starch material to a mixture of basic raw material wherein the starch material is selected from the group consisting of pre-gelatinized starch, modified starch, or combinations thereof. The method includes adding, 1.0% or less by weight, the starch material prior to shaping the structural clay product.

### FIELD OF THE INVENTION

The instant invention is directed to a method of improving the manufacture of structural clay products by the addition of a starch material.

### BACKGROUND OF THE INVENTION

The manufacture of bricks, blocks, clay roof tiles, sewer pipes, and refractory bricks is disclosed in, for example, U.S. Pat. Nos. 2,050,225, 2,251,687, 3,036,925, U.S. Patent Application No. 2005/0170945 and U.K. Patent No. 1,486,352, each of which are discussed below in greater detail.

A structural clay product manufacturer gathers starting materials, for example, surface clays and shales from a quarry, transfers those starting materials to a storage and processing area where they are mixed, crushed and ground to create a uniform dry, basic raw material. Manufacturers may then add additional items to the dry, basic raw material to enhance or alter the physical, structural, textural or cosmetic characteristics of the product.

A chronic and constant problem suffered by all structural clay product manufacturers is a lack of sufficient wet or “green” strength in freshly shaped clay products. The lack of green strength contributes to the distortion, cracking and crumbling of the products during the handling, drying and firing stages of manufacture. Structural clay product manufacturers must sell damaged products at a dramatic discount, if they can sell them at all. The lack of green strength results in a loss of raw materials, finished product, time, productivity, and money.

A refractory brick is different from a structural clay product. A refractory brick is a specialized brick used to line kilns and furnaces, typically has a lower density than common bricks, and is made of certain specialized heat dissipating materials. A common brick (or structural clay product) is discussed in greater detail below.

U.K. Patent No. 1,486,352 discloses refractory bricks made with the addition of 0.5-40.0% by weight of pre-gelatinized starch and oxidized starch. The use of pre-gelatinized starch resulted in low brick densities and a tendency to crack the bricks.

U.S. Pat. Nos. 2,050,225 and 2,251,687 each disclose refractory bricks made with water insoluble wood flour.

U.S. Pat. No. 3,036,925 discloses a refractory brick comprising a mixture of dead burned magnesia and chrome ore and between 0.5-5.0% by weight, of a carbohydrate (dextrin, starch, sugar).

U.S. Patent Application No. 2005/0170945 discloses a common brick made with 0.2-3.0% starch by weight, used as a borate migration inhibitor.

While each of the foregoing has provided advancement in the art of the manufacture of structural clay products, there is a need for improvement in the method of making structural clay products.

### SUMMARY OF THE INVENTION

A method of improving the manufacture of structural clay products through the addition of starches is disclosed herein. The method includes adding a starch material to a mixture of basic raw material wherein the starch material is selected from the group consisting of pre-gelatinized starch, modified starch, or combinations thereof. The method includes adding, 1.0% or less by weight, the starch material prior to shaping the structural clay product.

### DESCRIPTION OF THE FIGURES

For the purpose of illustrating the invention, there is shown in the figures a form that is presently preferred; it being understood, however, that this invention is not limited to the precise arrangements and instrumentalities shown.

FIG. 1 graphically illustrates the measured percentage of porosity of a green brick made according to the instant invention.

FIG. 2 graphically illustrates the measured green strength of a green brick made according to the instant invention.

FIG. 3 graphically illustrates the measured density of a green brick made according to the instant invention.

FIG. 4 graphically illustrates the measured plasticity index of a green brick made according to the instant invention.

FIG. 5 graphically illustrates the measured dry strength of a green brick made according to the instant invention.

### DESCRIPTION OF THE INVENTION

To simplify the following discussion, the structural clay product reference shall be a brick, it being understood, however, that the invention is not so limited.

A structural clay product, as used herein, means any product comprised of the basic raw material described below which is cast, pressed, molded, rammed, extruded or otherwise formed into a structural clay shape. Structural clay products include, but are not limited to, common bricks, pipes, clay tiles, blocks, and roofing materials. A structural clay product excludes a refractory brick. Common brick, as used herein, means a building, lining or paving material made by casting, pressing, molding, ramming or otherwise forming a clay into a predetermined shape while moist and then hardening that predetermined shape by drying and/or firing or burning it. Pipe, as used herein, means a hollow cylinder used for conducting a fluid, gas, solid material, or any combination thereof. Clay tile, as used herein, means a flat or curved piece of burned or fired clay whose uses may be structural or ornamental and include, but are not limited to roofing, flooring and wall covering. Block, as used herein, means a hollow, generally rectangular building unit made by casting, pressing, molding, ramming or otherwise forming a clay while moist and then hardening the block by drying and/or firing or burning it. Roofing material, as used herein, means a material made from fired or burned clay used to protect the exterior of a structure from the sun and the elements of nature.

The manufacture of structural clay products, as used herein, generally refers to the process of mixing the basic raw materials to form a moldable material, shaping the moldable material into a predetermined shape, and firing the predetermined shape in to the structural clay product. In one embodiment, the structural clay product manufacturer (manufacturer) gathers the starting material and transports that material to a processing site. The manufacturer then processes and refines the starting material to obtain a basic raw material. The manufacturer then combines and thoroughly mixes the basic raw material with water and any desired additives until achieving the desired plasticity resulting in a moldable material. The moldable material is shaped into the predetermined “green” structural clay product. The “green” structural clay product is stacked, dried, fired, and cooled resulting in a finished structural clay product.

The starting material of structural clay product manufacturing generally consists of surface clays, shales and fireclays. After gathering and transporting the starting material to a processing site, structural clay product manufacturers generally mix, crush and grind up the starting material to obtain a basic raw material. The manufacturer then blends and refines the basic raw material to obtain a uniform consistency.

Up to this point, the manufacturer generally keeps the starting material dry. The manufacturer then mixes the basic raw material with water and any desired additives (such as manganese, lime or iron to alter the color) until achieving a desired plasticity to create a homogeneous moldable material.

The manufacturer then shapes the moldable material into a desired form, such as a brick, block, roofing tile, or pipe to create a structural clay product. Manufacturers refer to these freshly molded or extruded structural clay products as “wet” or “green.”

The manufacturer stacks the green structural clay products mechanically or by hand to facilitate air drying prior to kiln firing. The green structural clay products will generally contain 10 to 30% water by weight. Drying typically takes between 24 to 48 hours to reduce the water content to the proper level. The stacks are then fired in a kiln at a temperature between 870° to 1,100° C. (depending on the type of raw material) where they are brought to final strength. The stacks of fired structural clay products cool after exiting the kiln. Manufacturers then sort the fired structural clay products, removing any defective pieces, and preparing the non-defective structural clay products for packaging and distribution.

When the green bricks are stacked, those bricks at the bottom of the stack are subject to the weight and compression of the numerous layers of green bricks above them. The weight can cause distorting, crumbling and cracking of the green bricks resulting in a damaged and unusable structural clay product. Additionally, the weight can cause the stack to collapse. This disrupts the manufacturing process resulting in a loss of time, marketable product and ultimately money. Additionally, the collapse can occur while the stack is in the kiln. This too can have an undesired impact upon the manufacturing process.

Basic raw material, as used herein, means the material obtained after: 1) gathering and transporting surface clays, shales and/or fireclays to a processing site; 2) mixing, crushing and grinding up the surface clays, shales and/or fireclays; and 3) blending and refining the surface clays, shales and/or fireclays to obtain a uniform blend and consistency.

Mixture, as used herein, means a combination or blending of elements into one mass so that the constituent parts are indistinguishable.

Shaping, as used herein, means to shape the basic raw material described above. Methods of shaping the basic raw material include, but are not limited to casting, pressing, molding, ramming, extruding or otherwise forming a structural clay product.

Plasticity, as used, herein, means a rheological property of solid or semisolid materials expressed as the degree to which they will flow or deform under applied stress and retain the shape so induced, either permanently or for a definite time interval.

In the present invention, a starch material is added into basic raw material prior to shaping. Adding, as used herein, refers to ways to incorporate the starch material into the basic raw material. Adding may include: the addition of starch material (in dry form) into the basic raw material; the addition of starch material (in solution form) into the basic raw material; the addition of starch material into water that is then added into the basic raw material; and/or any combination thereof. In one embodiment, the starch material comprises less than 1% by weight of the basic raw material. In another embodiment, the starch material comprises less than 0.6% by weight of the basic raw material. In yet another embodiment, the starch material comprises less than 0.2% by weight of the basic raw material. In yet another embodiment, the starch material comprises less than 0.1% by weight of the basic raw material. In yet another embodiment, the starch material comprises less than 0.05% by weight of the basic raw material.

Starch material, as used herein, refers to pre-gelatinized starch, modified starch, or any combination thereof. Pre-gelatinized starch, as used herein, means a physically modified starch which, in contrast to native starch, forms dispersions, pastes or gels with water. Pre-gelatinized starch may be granular starch (raw starch) which is heated so that the starch will dissolve in water. Potential sources for pre-gelatinized starch include, but are not limited to corn starch, potato starch, rice starch, wheat starch, arrachaca starch, buckwheat starch, banana starch, barley starch, cassava starch, kudzu starch, oca starch, sago starch, sorghum starch, sweet potato starch, taro starch, yam starch, fava bean starch, lentil starch, pea starch or combinations thereof. Modified starch, as used herein, means a water soluble polymer derived form a granular starch (raw starch) which is chemically modified. Methods of chemically modifying raw starch include, but are not limited to acetylation, chlorination, acid hydrolysis, or enzymatic action. Potential sources for modified starch include, but are not limited to corn starch, potato starch, rice starch, wheat starch, arrachaca starch, buckwheat starch, banana starch, barley starch, cassava starch, kudzu starch, oca starch, sago starch, sorghum starch, sweet potato starch, taro starch, yam starch, fava bean starch, lentil starch, pea starch or combinations thereof.

### EXAMPLES

A manufacturer can measure increases in plasticity on freshly produced structural clay products through the use of various types of equipment which test a material's green strength. For example, a clay material's green strength may be measured in pounds per square inch (psi) using the methods outlined in ASTM C67-06. Additionally, a manufacturer may measure the plasticity of a structural clay product after it has dried, but prior to burning or firing. For example, a clay material's plasticity may be measured from data acquired using the methods outlined in ASTM C67-06 and calculated as:

(psi)×(deflection)=plasticity

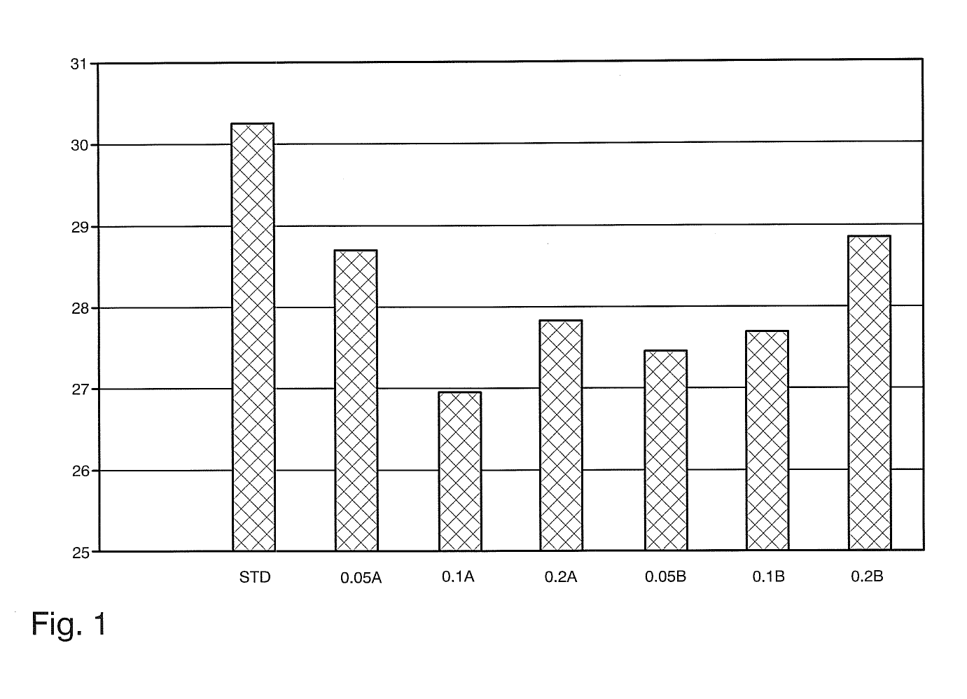

Referring now to FIGS. 1 through 5, the data generated to product FIGS. 1 through 5 resulted from the addition of measured amounts of Product A and measured amounts of Product B to a measured quantity of basic raw material.

Product A is a modified starch (carboxymethyl starch) commercially available as Aquajel from the AquaSol Corporation headquartered in Pineville, N.C. Carboxymethyl starch is a modified starch wherein a carboxymethyl group is added. Carboxymethyl starch is less prone to damage by heat and is water soluble.

Product B is a pre-gelatinized starch commercially available as Aquabind 100-B from the AquaSol Corporation headquartered in Pineville, N.C. A standard (STD) testing group was created wherein no amount of starch material was added to the mixtures of basic raw materials.

Researchers added Product A in amounts equal to 0.2 percent, 0.1 percent, and 0.05 percent of the total weight of the mixture of basic raw material, to separate batches of basic raw material respectively. Researchers added Product B in amounts equal to 0.2 percent, 0.1 percent, and 0.05 percent of the total weight of the mixture of basic raw materials, to separate batches of basic raw materials respectively. Product A and Product B were never added to the same batch of basic raw material which generated the data for FIGS. 1 through 5. Researchers combined either Product A or Product B with water and basic raw material and thoroughly mixed all ingredients resulting in a homogeneous moldable material for each experimental group.

Properties were determined in tests similar to those described in ASTM C67-06, “Standard Test Methods for Sampling and Testing Brick and Structural Clay Tile”; and ASTM C20-00, “Standard Test Methods for Apparent Porosity, Water Absorption, Apparent Specific Gravity, and Bulk Density of Burned Refractory Brick and Shapes by Boiling Water.”

FIG. 1 graphically illustrates the measured percentage of porosity in a green brick produced using the above methods.

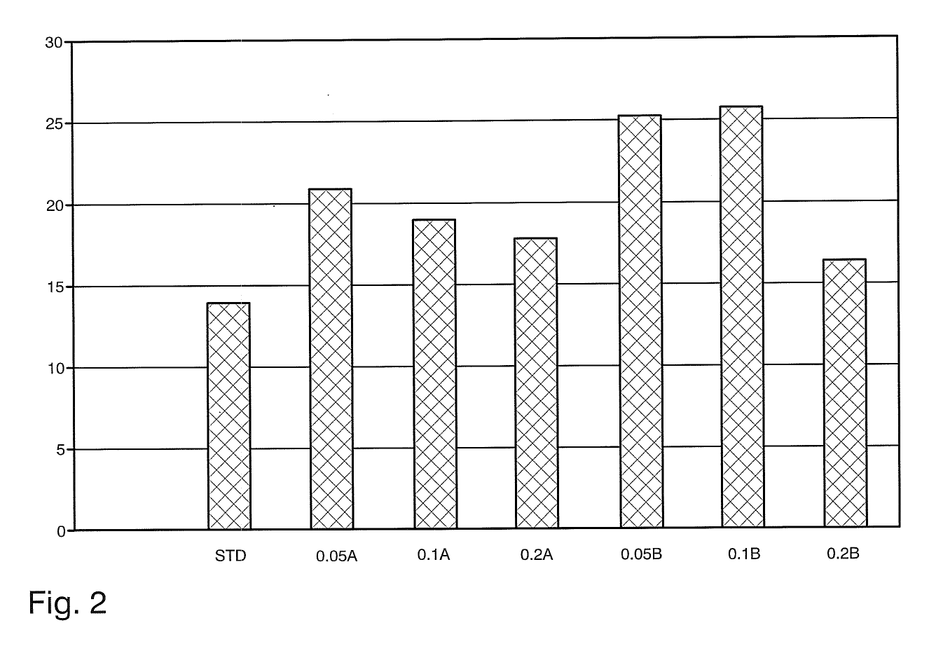

FIG. 2 graphically illustrates the measured green strength (psi) of a green brick produced using the above methods.

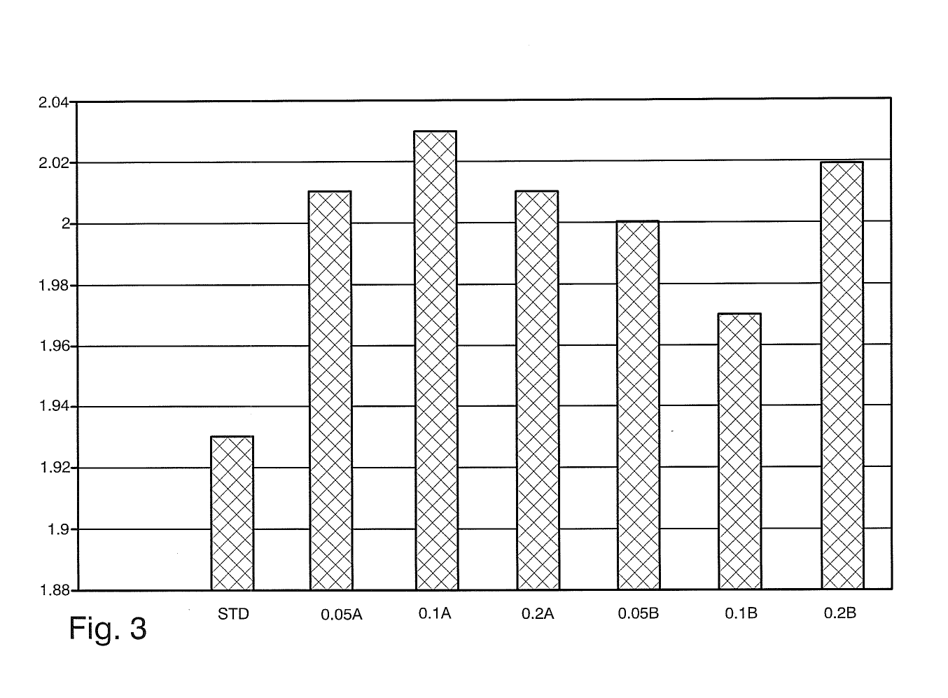

FIG. 3 graphically illustrates the measured density (g/m³) of a green brick produced using the above methods.

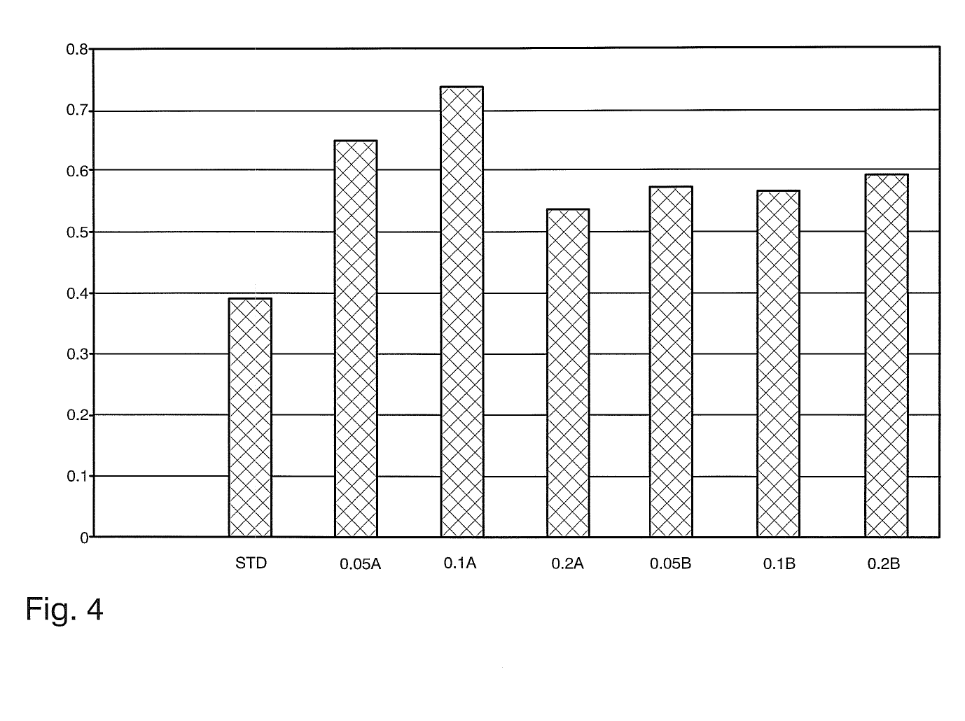

FIG. 4 graphically illustrates the measured plasticity index of a green brick produced using the above methods wherein: plasticity=(psi)×(deflection)

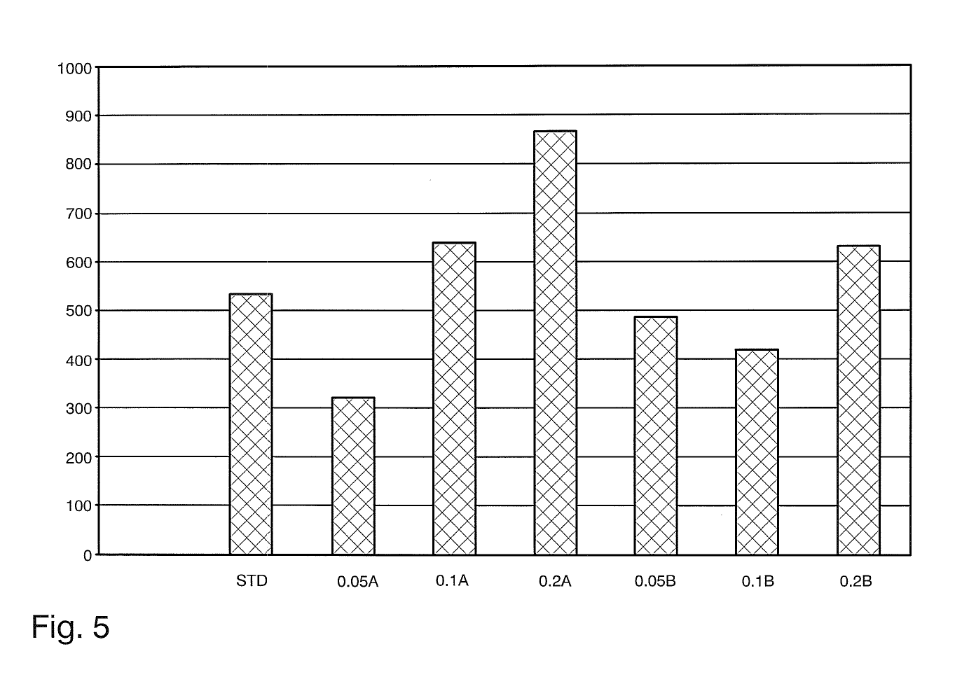

FIG. 5 graphically illustrates the measured dry strength (psi) of a green brick produced using the above methods.

The present invention may be embodied in other forms without departing from the spirit and the essential attributes thereof, and, accordingly, reference should be made to the appended claims, rather than to the foregoing specification, as indicated the scope of the invention.

We claim:

1. A method of improving the manufacture of structural clay products comprising the step of:
adding a starch material to a mixture of basic raw material;
wherein said starch material being selected from the group consisting of: pre-gelatinized starch, modified starch, or combinations thereof;
wherein said starch material being 1.0% or less by weight of said basic raw material;
prior to shaping said structural clay product.

2. The method of claim 1 wherein said pre-gelatinized starch being derived from starches selected from the group consisting of: corn starch, potato starch, rice starch, wheat starch, arrachaca starch, buckwheat starch, banana starch, barley starch, cassava starch, kudzu starch, oca starch, sago starch, sorghum starch, sweet potato starch, taro starch, yam starch, fava bean starch, lentil starch, pea starch or combinations thereof.

3. The method of claim 1 wherein said modified starch being derived from starches selected from the group consisting of: corn starch, potato starch, rice starch, wheat starch, arrachaca starch, buckwheat starch, banana starch, barley starch, cassava starch, kudzu starch, oca starch, sago starch, sorghum starch, sweet potato starch, taro starch, yam starch, fava bean starch, lentil starch, pea starch or combinations thereof.

4. The method of claim 1 wherein said structural clay product being selected from the group consisting of: a pipe, a clay tile, a brick, a block, or a roofing material.

5. The method of claim 1 wherein said added starch material being 0.6% or less by weight of said basic raw material.

6. The method of claim 1 wherein said added starch material being 0.2% or less by weight of said basic raw material.

7. The method of claim 1 wherein said added starch material being 0.1% or less by weight of said basic raw material.

8. The method of claim 1 wherein said added starch material being 0.05% or less by weight of said basic raw material.

9. A method of improving the manufacture of structural clay products comprising the step of:
adding a starch material to a mixture of basic raw material wherein said starch material being selected from the group consisting of: pre-gelatinized starch, modified starch or combinations thereof;
said pre-gelatinized starch being derived from starches selected from the group consisting of: corn starch, potato starch, rice starch, wheat starch, arrachaca starch, buckwheat starch, banana starch, barley starch, cassava starch, kudzu starch, oca starch, sago starch, sorghum starch, sweet potato starch, taro starch, yam starch, fava bean starch, lentil starch, pea starch or combinations thereof;
said modified starch being derived from starches selected from the group consisting of: corn starch, potato starch, rice starch, wheat starch, arrachaca starch, buckwheat starch, banana starch, barley starch, cassava starch, kudzu starch, oca starch, sago starch, sorghum starch, sweet potato starch, taro starch, yam starch, fava bean starch, lentil starch, pea starch or combinations thereof;
wherein said starch material being 1.0% or less by weight of said basic raw material;
wherein said structural clay product being selected from the group consisting of: a pipe, a clay tile, a brick, a block, or a roofing material;
prior to shaping said structural clay product.

10. The method of claim 9 wherein said added starch material being 0.6% or less by weight of said basic raw material.

11. The method of claim 9 wherein said added starch material being 0.2% or less by weight of said basic raw material.

12. The method of claim 9 wherein said added starch material being 0.1% or less by weight of said basic raw material.

13. The method of claim 9 wherein said added starch material being 0.05% or less by weight of said basic raw material.

14. A method of improving the plasticity of structural clay products comprising the step of:
adding a starch material to a mixture of basic raw material wherein said starch material being selected from the group consisting of: pre-gelatinized starch, modified starch or combinations thereof;
wherein said pre-gelatinized starch being derived from starches selected from the group consisting of: corn starch, potato starch, rice starch, wheat starch, arrachaca starch, buckwheat starch, banana starch, barley starch, cassava starch, kudzu starch, oca starch, sago starch, sorghum starch, sweet potato starch, taro starch, yam starch, fava bean starch, lentil starch, pea starch or combinations thereof;
wherein said modified starch being derived from starches selected from the group consisting of: corn starch, potato starch, rice starch, wheat starch, arrachaca starch, buckwheat starch, banana starch, barley starch, cassava starch, kudzu starch, oca starch, sago starch, sorghum starch, sweet potato starch, taro starch, yam starch, fava bean starch, lentil starch, pea starch or combinations thereof;
wherein said starch material being 1.0% or less by weight of said basic raw material;
wherein said structural clay product being selected from the group consisting of: a pipe, a clay tile, a brick, a block, or a roofing material;
prior to shaping said structural clay product.
